(19) United States
(12) Patent Application Publication
(10) Pub. No.: US 2008/0185201 A1
(43) Pub. Date: Aug. 7, 2008

(54) Spring Hybrid Drive

(76) Inventor: Timothy Bishop, Northants (GB)

Correspondence Address: AMSTER, ROTHSTEIN & EBENSTEIN LLP, 90 PARK AVENUE, NEW YORK, NY, 10016, US

(21) Appl. No.: 11/793,672

(22) PCT Filed: Dec. 22, 2005
(86) PCT No.: PCT/GB2005/005022

§ 371 Date: Nov. 20, 2007

(30) Foreign Application Priority Data
Dec. 22, 2004 (GB) 0428089.7

(51) Int. Cl. B60K 6/10

(52) U.S. Cl. 180/165

(57) ABSTRACT

A power storage mechanism comprising an elastic element, one end of the spring being connected to a first shaft and the other end being connected to a second shaft whereby rotation of the shafts at different speeds can cause the storage of energy in the elastic element, the shafts being interconnected by a continuously variable transmission and/or a differential whereby the relative rotational speeds thereof can be controlled.

The present invention relates to a power storage mechanism, and more especially to a power storage mechanism as an alternative to an electric “hybrid” drive particularly suited to lightweight or city vehicles, mopeds and motorcycles.

A hybrid car is usually driven by a combination of fuel and electric power and typically contains parts of both gasoline and electric vehicles in an attempt to benefit from the advantages of both systems. The hybrid car is typically provided with an electric motor providing the power to the wheels, batteries to supply the motor with electricity, and also a separate fuel engine that powers a generator. The engine is usually quite small, efficient and runs at one speed to provide sufficient power for the car at a cruise speed. When acceleration is required the batteries provide the extra power required and when the car is reducing in speed the battery recharges. There are of course many other petrol, diesel, gas and electric versions and derivatives available.

Hybrid cars were developed primarily to generate savings in vehicle fuel consumption. This could be enhanced by recovering energy during braking. However, until recently the use of devices to recoup some of the energy wasted in braking have not been very cost-effective.

With the new fears of oil supply and push to introduce fuel-efficient vehicles, “hybrid” or dual or complimentary powered vehicles are now increasingly being seen as a worthwhile alternative to the standard and widely used petrol engine. The difficulty with previously proposed systems has been in harnessing the stored energy in an appropriately safe and regenerative manner.

The present invention seeks to provide a power storage mechanism that addresses the aforementioned problems.

Accordingly the present invention is directed to a power storage mechanism comprising an elastic element, one end of the spring being connected to a first shaft and the other end being connected to a second shaft whereby rotation of the shafts at different speeds can cause the storage or release of energy in the elastic element, the shafts being interconnected by a continuously variable transmission and/or a differential whereby the relative rotational speeds thereof can be controlled.

There is preferably a controller such as an electronic control unit which receives signals from one or more sensors indicating the condition of the mechanism or the equipment in which it is installed. In response to inputs from those sensors the controller can adjust the drive ratio of the CVT and/or the power output from a drive device such as an engine that can be attached to the first shaft and/or the drive ratio from the second shaft via the adjustment of a further transmission mechanism such as another CVT connected to the second output shaft.

Further advantageous features are disclosed in the dependent claims.

Instead of the usual electric power assistance and regeneration of braking energy the present invention stores the energy in a mechanical spring

The present invention allows the use and regeneration of the potential energy in a controlled manner. It also allows the storage device to be re-charged from an external source such as an internal combustion motor whilst in motion.

Systems in accordance with the present invention will now be described by way of example only with reference to the accompanying drawings, in which;

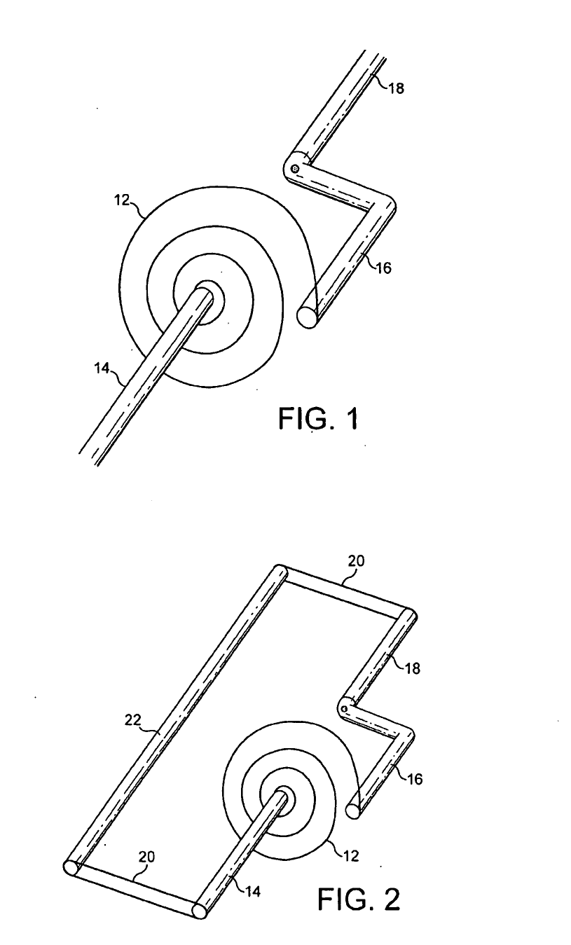

FIG. 1 shows a spring mechanism;

FIG. 2 shows a spring mechanism attached to a further shaft; and

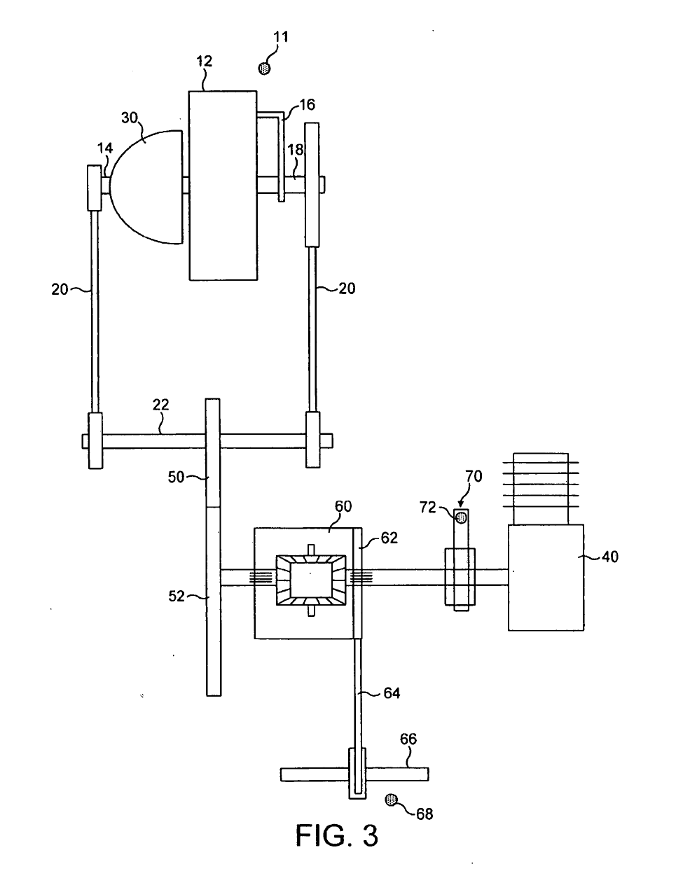

FIG. 3 shows a spring mechanism connected in series.

### EXAMPLE 1

A spring or a series of springs are arranged such that there is an output from both ends of the coil/coils.

In FIG. 1 a spring 12 is attached to a shaft 14 at its centre, and at its extremity it is attached to a crank 16 attached to another shaft mounted on the same centre-line as the first. If both shafts were left to transmit the potential spring energy they would both spin violently in opposite directions until that energy was dissipated.

As shown in FIG. 2, if there is taken a drive from both these shafts, for example by chain 20, to another single cross-shaft 22, the opposite then happens. The potential energy of the spring is held totally in check by the opposing twisting forces on the single shaft.

As a result, neither of the above scenarios is of any use.

As shown in FIG. 3, control can be imposed by the addition of a continually variable transmission (CVT) 30 into one of the driver, the ideal being a pawl and ratchet or variable roller drive of a readily available type.

At the zero position equilibrium is maintained. As soon as the CVT 30 is shifted to a ratio different to its direct drive counterpart on the other side of the spring a change in opposing torques exists and motion is thus created. The solid output shaft 18 will rotate at a given torque. One output of the spring will rotate at a speed directly fixed to that of the output shaft, whilst the other will rotate at a slightly different speed depending upon the CVT 30 gear ratio chosen. Thus the entire spring rotates in one direction, but with a differential in rotational speed between the outputs until eventually unwound.

Shifting the CVT ratio in the opposite direction results in either a reversal of the shaft rotation or a regeneration (wind-up) of the spring dependent upon the external rotational forces imposed upon the output shaft. The result is a high efficiency energy drive and recuperation system, which can potentially be more efficient than the electric equivalent.

Thus the system of example 1 comprises an elastic member 12 capable of being held under torsional stress between two shafts 14, 18. A continuously variable transmission 30 is coupled between the two shafts and by adjusting the transmission ratio of the CVT the degree of force transfer between the shafts, or between each shaft and the elastic member can be controlled. In that way the loading and unloading of the elastic member can be maintained at a usable rate.

### EXAMPLE 2

The system can never give out more energy than it has stored, and therefore requires a periodic “top-up” 40. This can be achieved by a stand-alone engine of any suitable type (for example, an internal combustion engine).

The difficulty inherent in the “top-up” mechanism is that direct wind-up of the spring will result in upset to the equilibrium of the output shaft and an undesirable step change in output torque.

FIG. 3 shows a possible solution in which the output from the solid shaft 22 is connected to a sun wheel 50 which is in turn connected by a chain or gear 52 to a differential 60. Another sun wheel 62 is solidly connected to the output from an internal combustion engine but with a one-way clutch or other one-way drive means 70 in circuit to prevent the engine being driven backwards by reverse torque. The one way clutch 70 may also include a load sensor 72 and a brake band or other retardation means that is controlled by a controller in response to the output of the load sensor to avoid spinning of the internal combustion engine in preference to severe regeneration of the spring under certain circumstances.

The output to the wheels is taken from the body of the differential via a further chain 64 to shaft 66. A torque sensing device 68 monitors the torque output at the final drive versus the torque requirement from the driver (in simplest form, throttle position).

Power from the “top-up” engine is primarily stored in the spring 12 and detected by the load sensor 11. The energy is released to the final output as required, under the control of a control mechanism that governs the operation of the CVT. Thus, when relatively little power is needed, as when cruising upon a flat surface for example, power can be extracted at a very advantageous ratio from the spring 12. When more power is required the spring ratio changes and unwinds faster. As the torque begins to diminish below the requirement, the “top-up” engine starts up to either replenish the spring or make up the output losses. The reverse is true under downhill motion or braking, where the CVT is changed in ratio to regenerate the spring 12 using the inertia of the vehicle. The CVT ratio is controlled by the control unit in response to sensed operating conditions which can include power demand.

The control mechanisms potentially include as inputs; spring load (or pressure), torque requirement (throttle), torque output (at final drive), call for performance and economy mode. Potential outputs include: CVT position, internal combustion engine on/off, internal combustion motor clutch/brake-band.

The control mechanism could be located within the perimeter of a driven wheel of the vehicle. For example, in the case of a bicycle the control mechanism could be placed to fill the rear wheel.

A moped could likewise use a mechanical control with an internal combustion engine for support.

A motor vehicle could use electronic control of a larger spring/constant speed internal combustion engine.

Simple calculations suggest that a Smart Car, appropriately modified could travel one mile on spring power with reasonable rates of acceleration and a peak speed of 50 mph. This would be “topped-up” by a 20 bhp internal combustion engine designed for peak fuel economy at a constant speed. 100 mpg might be expected.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A power storage mechanism comprising an elastic element, one end of the spring being connected to a first shaft and the other end being connected to a second shaft whereby rotation of the shafts at different speeds can cause the storage or release of energy in the elastic element, the shafts being interconnected by a continuously variable transmission whereby the relative rotational speeds thereof can be controlled.

2. The power storage mechanism according to claim 1, further comprising a third shaft and a further variable transmission coupled between the second shaft and the third shaft, whereby the third shaft can be driven by the second shaft.

3. The power storage mechanism as claimed in according to claim 1, further comprising a drive means for driving the first shaft to rotate.

4. The power storage mechanism according to claim 3, further comprising a controller coupled to one or more sensors and configured to control the continuously variable transmission in response to conditions sensed by each of the one or more sensors.

5. The power storage mechanism according to claim 4, wherein the controller is arranged so as to cause the second shaft to rotate more slowly than the first shaft in response to sensed conditions indicative of a relatively low demand for power from the second shaft.

6. The power storage mechanism according to claim 4, wherein the controller is arranged so as to cause the second shaft to rotate more quickly than the first shaft in response to sensed conditions indicative of a relatively high demand for power from the second shaft.

7. The power storage mechanism according to claim 1, wherein the elastic element is a torsion spring.

8. A power storage mechanism according to claim 1, wherein the continuously variable transmission and/or a differential is/are coupled to the first and second shafts by means of two further shafts that are rotationally coupled to the first and second shafts respectively.

9. The power storage mechanism according to claim 8, wherein the shafts are interconnected by a continuously variable transmission.

10. The power storage mechanism according to claim 1, wherein the second shaft is connected to a first planet wheel of a differential, a second drive means is connected to a second planet wheel of the differential and an output is coupled to the body of the differential, such that power from the second drive means may pass to the output shaft and to the second shaft whereby energy from the second drive means may be stored in the elastic element.

11. The power storage mechanism according to claim 10, further comprising a one-way drive means coupled between the second planet wheel and the second drive means for resisting the flow of energy from the elastic element to the second drive means.

12. The power storage mechanism according to claim 3, further comprising a clutch whereby the drive means is coupled to the first shaft, the clutch being such as to inhibit the transmission of rotation from the first shaft to the drive means.

13. (canceled)
